(19) United States
(12) Patent Application Publication
(10) Pub. No.: US 2025/0357037 A1
(43) Pub. Date: Nov. 20, 2025

(54) Power Inductor Component with Ultra-Low Inductance and Low Alternating Current Loss

(71) Applicant: CYNTEC CO., LTD., Hsinchu (TW)

(72) Inventors: Chao-Ting Lin, Hsinchu (TW); Po-Kai Lai, Hsinchu (TW)

(73) Assignee: CYNTEC CO., LTD., Hsinchu (TW)

(21) Appl. No.: 19/172,598

(22) Filed: Apr. 7, 2025

Related U.S. Application Data
(60) Provisional application No. 63/648,674, filed on May 17, 2024.

(51) Int. Cl. H01F 27/255; H01F 27/28

(52) U.S. Cl. CPC H01F 27/255; H01F 27/28

(57) ABSTRACT

A power inductor component includes a conductor and a magnetic powder material mold. The conductor includes two bending portions and two electrode portions respectively attached to the two bending portions. The magnetic powder material mold and the conductor are formed into an integral structure. The conductor is embedded in the integral structure. The magnetic powder material mold includes a first magnetic powder portion and a second magnetic powder portion. The conductor has less than one turn. The first magnetic powder portion is disposed on an outer side of the conductor. The second magnetic powder portion is disposed on an inner side of the conductor. The integral structure includes a first surface and a second surface opposite to each other, a third surface and a fourth surface opposite to each other, and a fifth surface and a sixth surface opposite to each other.

### CROSS REFERENCE TO RELATED APPLICATIONS

This application claims the benefit of U.S. Provisional Application No. 63/648,674, filed on May 17, 2024. The content of the application is incorporated herein by reference.

### BACKGROUND OF THE INVENTION

### 1. Field of the Invention

The present invention illustrates a power inductor component, and more particularly, a power inductor component with ultra-low inductance and low alternating current loss.

### 2. Description of the Related Art

Inductors are widely used in various electronic devices, such as smartphones, tablets, and laptops. As the performance demands of these devices increase, so does their energy consumption. Therefore, reducing the energy loss in power integrated circuits (ICs) and inductors becomes crucial. Energy loss in power circuits is influenced by operating condition. For example, it increases with higher load currents and frequencies. In switching direct current (DC) to DC converter circuits, increasing the switching frequency allows for the use of smaller inductors with lower inductance values, reducing the required mounting area and enabling device miniaturization. This approach is common in small portable devices.

However, for smaller inductors, conventional hot-press molding processes often damage conductors due to high molding pressure, potentially leading to open or short circuits. Additionally, conventional composite core power inductors typically use ferrite cores with a surface coating, creating a gap between the conductor and the core that increases magnetic flux leakage and noise. Conventional molding processes for power inductors may encounter core cracking due to insufficient adhesion between magnetic powders when the conductor is too wide. Furthermore, the side electrodes in these inductors are located outside the core, hindering the full utilization of the core volume.

Therefore, there is a need for a small power inductor component that can effectively reduce alternating current (AC) loss, fully utilize the core volume, and used for the limitations of conventional inductor designs.

### SUMMARY OF THE INVENTION

In an embodiment, a power inductor component is disclosed. The power inductor component comprises a conductor and a magnetic powder material mold. The conductor comprises two bending portions and two electrode portions respectively attached to the two bending portions. The magnetic powder material mold and the conductor are formed into an integral structure. The conductor is embedded in the integral structure. The magnetic powder material mold comprises a first magnetic powder portion and a second magnetic powder portion. The conductor has less than one turn. The first magnetic powder portion is disposed on an outer side of the conductor. The second magnetic powder portion is disposed on an inner side of the conductor. The integral structure comprises a first surface and a second surface opposite to each other, a third surface and a fourth surface opposite to each other, and a fifth surface and a sixth surface opposite to each other.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a power inductor component according to an embodiment of the present invention.

FIG. 2 is a cross-sectional view along line 2-2′ of the power inductor component in FIG. 1.

FIG. 3 is a schematic diagram of six surfaces of an integral structure of the power inductor component in FIG. 1.

FIG. 4 is a schematic diagram of a first surface and a second surface of the integral structure of the power inductor component in FIG. 1.

FIG. 5 is a schematic diagram of a fifth surface and a sixth surface of the integral structure of the power inductor component in FIG. 1.

FIG. 6 is a schematic diagram of a fourth surface of the integral structure of the power inductor component in FIG. 1.

FIG. 7 is a schematic diagram of a third surface of the integral structure of the power inductor component in FIG. 1.

FIG. 8 is a dimension drawing of an inner space below a fifth surface of the power inductor component in FIG. 1.

FIG. 9 is a dimension drawing of an inner space below a second surface of the power inductor component in FIG. 1.

FIG. 10 is a schematic diagram of two inner radius fillets of a U-shaped portion of a conductor of the power inductor component in FIG. 1.

### DETAILED DESCRIPTION

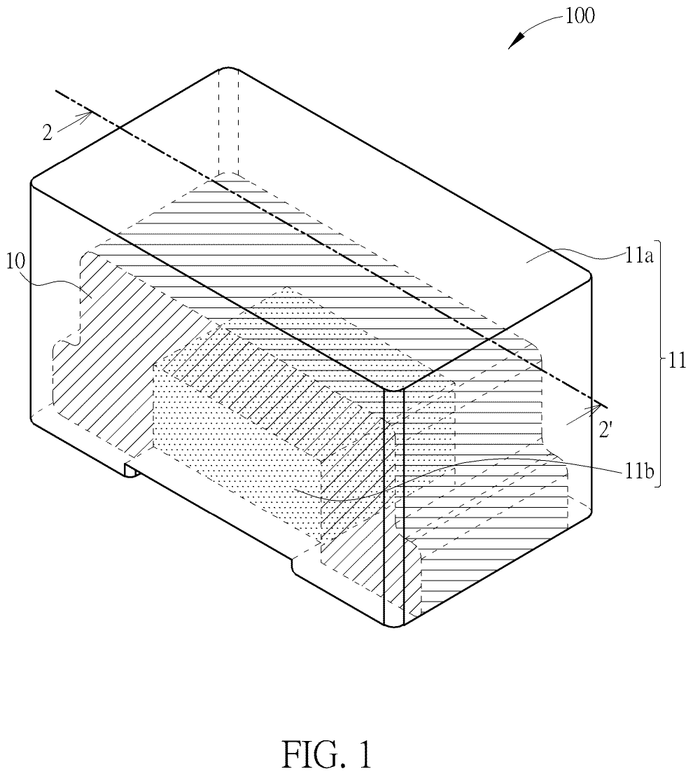

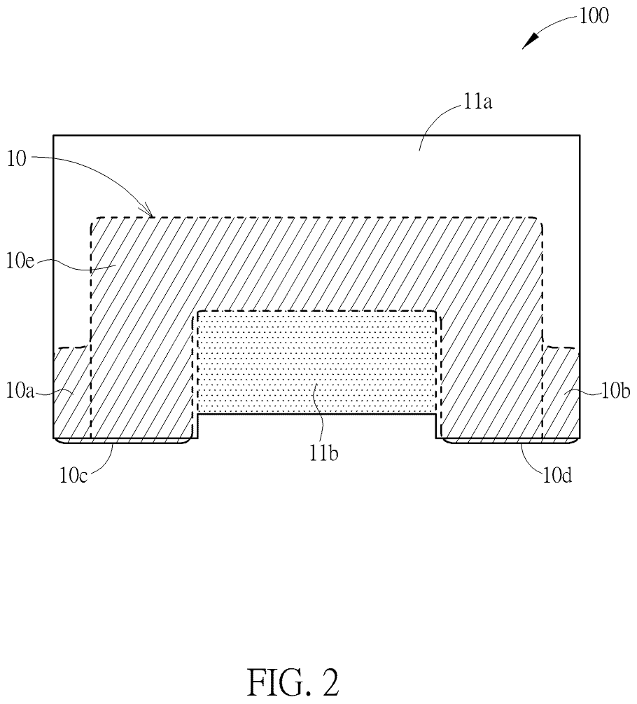

FIG. 1 is a schematic diagram of a power inductor component 100 according to an embodiment of the present invention. FIG. 2 is a cross-sectional view along line 2-2′ of the power inductor component 100. The power inductor component 100 is designed to overcome the limitations of traditional winding processes and composite magnetic core structures by utilizing a specific size formula for the conductor and a one-piece molding structure made of magnetic powder material. This design allows for efficient use of the core volume and significantly reduces alternating current (AC) losses caused by current and voltage changes in AC circuits. The design also optimizes the ratio of the conductor's side width to the component's length and width, maximizing the contact area between the conductor and magnetic powder material to prevent core cracking.

In FIG. 1 and FIG. 2, the power inductor component 100 includes a conductor 10 and a magnetic powder material mold 11. The conductor 10 is typically made of copper, chosen for its excellent electrical conductivity. However, the embodiment is not limited to copper, and other conductive materials could be used. The conductor 10 is not a traditional wound wire, but rather a single, bent piece, designed to minimize path length and reduce impedance. It is embedded within the magnetic powder material mold 11, forming a single, integrated structure. This configuration allows for a higher conductor volume ratio compared to traditional designs, contributing to lower inductance and higher efficiency. The conductor 10 includes a first bending portion 10a, a second bending portion 10b, a first electrode portion 10c, and a second electrode portion 10d (as shown in FIG. 2). The first electrode portion 10c is attached to the first bending portion 10a. The second electrode portion 10d is attached to the second bending portion 10b. In the embodiment, the first electrode portion 10c and the second electrode portion 10d are covered (coated) with a Nickel layer and a Tin layer. In another embodiment, the first electrode portion 10c and the second electrode portion 10d are coated with a Tin layer.

The conductor 10 further includes a U-shaped portion 10e (as shown in FIG. 2). The U-shaped portion 10e is formed by bending a portion of the conductor 10 into a U-shape. The base portion of the U-shaped portion 10e is the portion closest to the base of the conductor 10. The two electrode portions 10c and 10d are the two terminals of the U-shaped portion that extend from the base portion. This configuration of the conductor 10 ensures that the electrical current flows efficiently through the conductor 10, minimizing energy loss and maximizing the performance of the power inductor component 100.

As previously mentioned, the magnetic powder material mold 11 and the conductor 10 are formed into the integral structure. The conductor 10 is embedded in the integral structure. In other words, the conductor 10 is surrounded by and encased within the solid structure of the integral structure of the inductor. This is in contrast to traditional wound inductors, where the conductor is wrapped around a separate core. In the embodiment, the integral structure is made of a magnetic powder material that is compressed and heated to form a solid unit. Embedding the conductor 10 in this way allows for a more compact design and can improve the electrical performance of the inductor. The magnetic powder material mold 11 includes a first magnetic powder portion 11a and a second magnetic powder portion 11b. The first magnetic powder portion 11a and the second magnetic powder portion 11b can be designed to have a magnetic permeability selected based on the required inductance of the power inductor component 100. Further, the first magnetic powder portion 11a and the second magnetic powder portion 11b can be also designed to have a high magnetic saturation point. This helps to prevent the component from saturating at high currents.

In one embodiment, the first magnetic powder portion 11a and the second magnetic powder portion 11b are the same material type to ensure uniform magnetic properties throughout the power inductor component 100. In other words, the consistent material type for both portions 11a and 11b helps to maintain consistent magnetic properties, ensuring that the power inductor component 100 functions efficiently and reliably. In another embodiment, the first magnetic powder portion 11a and the second magnetic powder portion 11b are different material types to achieve specific magnetic properties and performance characteristics in the power inductor component 100. For example, the first magnetic powder portion 11a comprises a material with high permeability and low loss at high frequencies, while the second magnetic powder portion 11b comprises a material with high saturation magnetization and good temperature stability. This combination enables the power inductor component 100 to achieve high inductance efficiency and high current capability. Any reasonable technology or material modification falls into the scope of the embodiments. The power inductor component 100 includes the conductor 10 having less than one turn, which means the conductor 10 does not form a complete loop. The conductor 10 with less than one turn reduces the total length of the conductor, which in turn lowers the DC resistance (DCR) and improves the efficiency of the power inductor component 100. This design is particularly used for low inductance applications where the DCR is a significant contributor to overall losses. Further, referring to FIG. 1, the first magnetic powder portion 11a is disposed on an outer side of the conductor 10, and the second magnetic powder portion 11b is disposed on an inner side of the conductor 10. In the embodiment, the first magnetic powder portion 11a and the second magnetic powder portion 11b provide a magnetic path for the magnetic flux generated by the current flowing through the conductor 10.

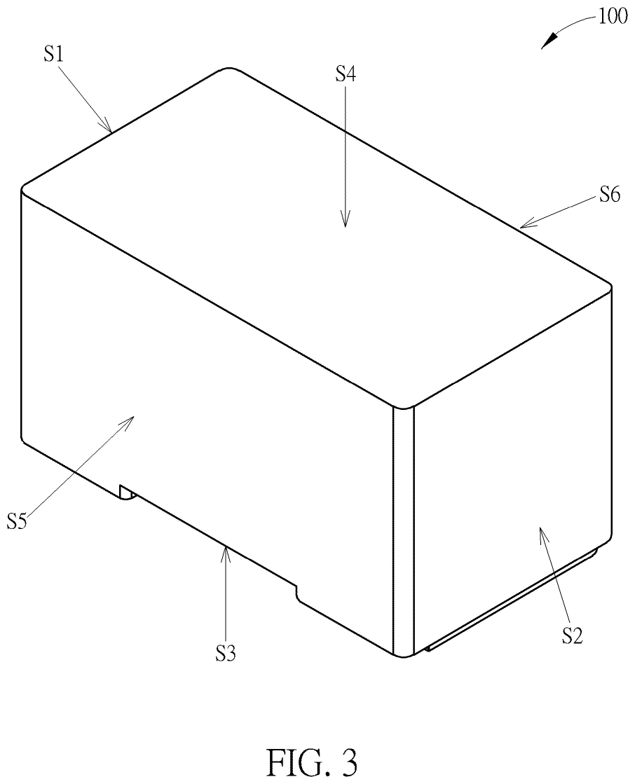

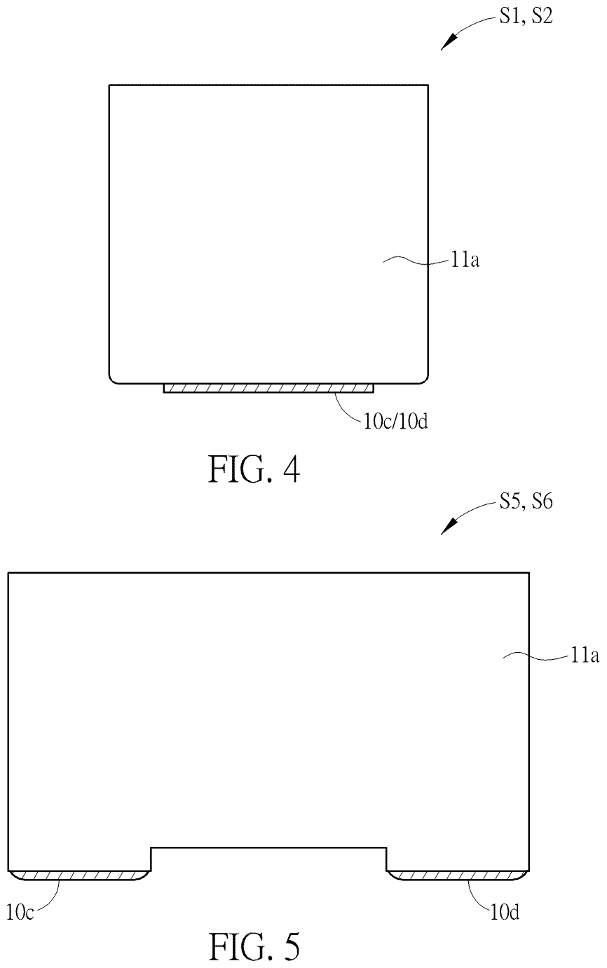

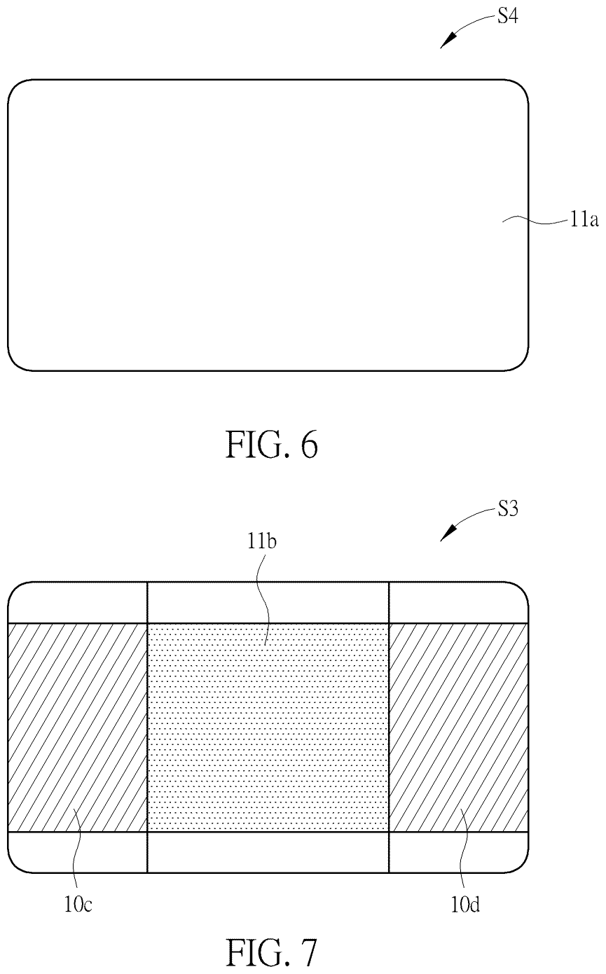

FIG. 3 is a schematic diagram of six surfaces S1 to S6 of the integral structure of the power inductor component 100. FIG. 4 is a schematic diagram of a first surface S1 and a second surface S2 of the integral structure of the power inductor component 100. FIG. 5 is a schematic diagram of a fifth surface S5 and a sixth surface S6 of the integral structure of the power inductor component 100. FIG. 6 is a schematic diagram of a fourth surface S4 of the integral structure of the power inductor component 100. FIG. 7 is a schematic diagram of a third surface S3 of the integral structure of the power inductor component 100. In FIG. 3, the integral structure of the power inductor component 100 is cubic in appearance and includes the first surface S1 and the second surface S2 opposite each other, the third surface S3 and the fourth surface S4 opposite each other, and the fifth surface S5 and the sixth surface S6 opposite each other. The first surface S1 is located on the right side of the power inductor component 100, while the second surface S2 is located on the left side, directly opposite the first surface S1. The first surface S1 and the second surface S2 are surfaces where the first magnetic powder portion 11a and the electrode portion 10c/10d are visible. The fifth surface S5 is located on the front side of the power inductor component 100, while the sixth surface S6 is located on the back side, directly opposite the fifth surface S5. The fifth surface S5 and the sixth surface S6 are surfaces where the first magnetic powder portion 11a and the electrode portions 10c and 10d are visible. In FIG. 6, the fourth surface S4 is defined by the perspective of viewing the power inductor component 100 from the top, showing the top face of the component. In FIG. 7, the third surface S3 is defined by the perspective of viewing the power inductor component 100 from the bottom, showing the bottom face of the component. The third surface S3 is a surface where the second magnetic powder portion 11b, the electrode portions 10c, and 10d are visible. In the embodiment, the third surface S3 can also be regarded as a mounting surface. The mounting surface provides a stable base for the power inductor component 100 and allows for electrical connections to be made. For example, the mounting surface of the power inductor component 100 can be the third surface S3 that is used for attaching the power inductor component 100 to a circuit board or other surface. Further, in the power inductor component 100, two bending portions 10a and 10b are in contact with the first surface S1 and the second surface S2 of the integral structure, respectively. Two electrode portions 10c and 10d are in contact with the third surface S3 of the integral structure.

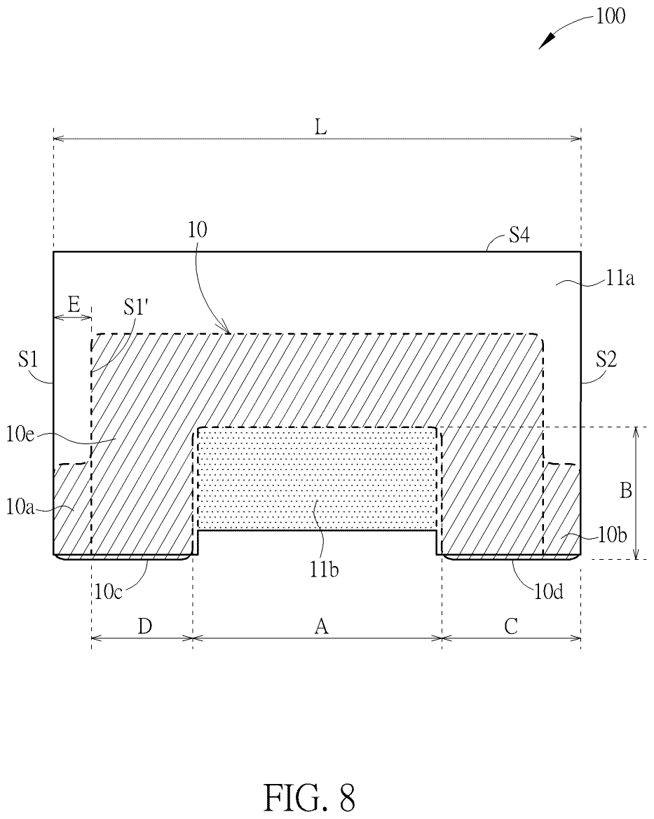

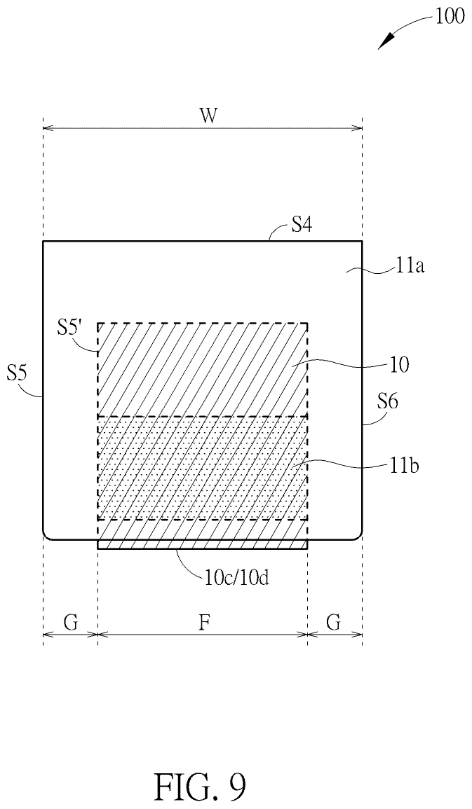

FIG. 8 is a dimension drawing of an inner space below the fifth surface S5 of the power inductor component 100. FIG. 9 is a dimension drawing of an inner space below the second surface S2 of the power inductor component 100. In FIG. 8 and FIG. 9, “A” is an inner space length. “B” is an inner space height. “C” is a base fillet length. “D” is a line width. “E” is a long sidewall width. “F” is a line thickness. “G” is a short sidewall width. “L” is a component length. “W” is a component width. In FIG. 8, the inner space length A is a horizontal distance between the two electrode portions 10c and 10d of the conductor 10. The inner space height B is a vertical distance between a top surface of the second magnetic powder portion 11b contacting the conductor 10 and the two electrode portions 10c and 10d of the conductor 10. The base fillet length C is a horizontal distance between the edge of the electrode portion 10d and the outer edge of the integral structure on the same side, representing the length of the electrode portion 10d of the power inductor component 100. Further, the base fillet length C can be calculated by C=D+E. The line width D is defined as a width of the conductor 10. The long sidewall width E is a distance between a surface S1′ of a short side of the conductor 10 and the first surface S1 of the integral structure of the power inductor component 100. In FIG. 9, the line thickness F is defined as the horizontal width of the conductor 10 when the integral structure of the power inductor component 100 is viewed from the second surface S2. The short sidewall width G is a distance between a surface S5′ of a long side of the conductor 10 and the fifth surface S5 of the integral structure of the power inductor component 100. The component length L is defined as a distance between the first surface S1 and the second surface S2 of the integral structure of the power inductor component 100. The component width W is defined as a distance between the fifth surface S5 and the sixth surface S6 of the integral structure of the power inductor component 100. In the power inductor component 100, a ratio of the long sidewall width E to the component length L ranges from 5% to 15%. This design increases the contact area between the conductor and the magnetic powder material. It helps to prevent the magnetic core (magnetic powder portion 11a or 11b) from cracking. If the long sidewall width E is insufficient, the magnetic core may crack during the hot-press molding process. In other words, for the surfaces S5 and S6, by ensuring an appropriate thickness of the sidewall, the design safeguards the magnetic core from cracking or fracturing during the hot-press molding process. This is important for the design of the power inductor component 100, as it utilizes a high conductor volume ratio, which can increase the stress on the magnetic core during molding. In one embodiment, by using the 1005 size (1.0 millimeter (mm)×0.5 mm), the long sidewall width E is 0.075 mm, and the component length L is 1.0+0.2 mm, resulting in an E/L ratio (the ratio of the long sidewall width E to the component length L) ranging from 6.25% to 9.37%. By maintaining this ratio within the specified range (5% to 15%), the design effectively prevents magnetic core cracking during the hot-press molding process.

In the power inductor component 100, a ratio of the short sidewall width G to the component width W ranges from 10% to 30%. Similarly, this design increases the contact area between the conductor and the magnetic powder material. It helps to prevent the magnetic core (magnetic powder portion 11a or 11b) from cracking. If the short sidewall width G is insufficient, the magnetic core may crack during the hot-press molding process. In other words, for the surfaces S1 and S2, by ensuring an appropriate thickness of the sidewall, the design safeguards the magnetic core from cracking or fracturing during the hot-press molding process. This is important for the design of the power inductor component 100, as it utilizes the high conductor volume ratio, which can increase the stress on the magnetic core during molding. In one embodiment, by using the 1005 size (1.0 mm×0.5 mm), the short sidewall width G is 0.075 mm, and the component width W is 0.5±0.2 mm, resulting in a G/W ratio (the ratio of the short sidewall width G to the component width W) ranging from 10.7% to 25%. By maintaining this ratio within the specified range (10% to 30%), the design effectively prevents magnetic core cracking during the hot-press molding process.

Further, in the power inductor component 100, a relationship between the inner space length A and the inner space height B satisfies the following condition:

$$- 2.5 mm < ( 2 \times B - A ) < 2.5 mm$$

This condition ensures the effective utilization of the core volume and achieves the desired inductance value. If the dimensions of the inner space length A and the inner space height B are outside of this specified range, it can impact the inductance of the final product, potentially affecting its performance. By maintaining the relationship between the inner space length A and the inner space height B within the given range, the design can optimize the magnetic flux and ensure that the volume of the second magnetic powder portion 11b is used as efficiently as possible. This helps achieve the desired inductance characteristics while keeping the power inductor component 100 compact.

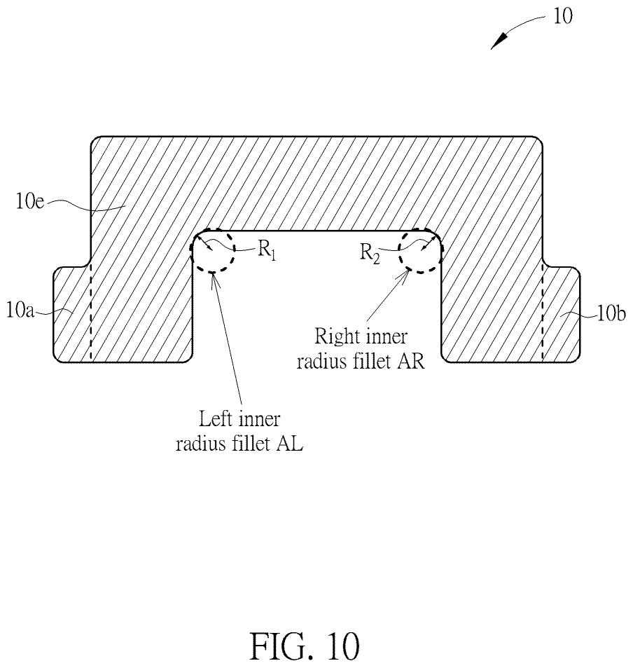

FIG. 10 is a schematic diagram of two inner radius fillets AL and AR of the U-shaped portion 10e of the conductor 10 of the power inductor component 100. In the power inductor component 100, two fillets are located at the inner junctions where the inner surface of the U-shaped portion 10e meets the vertical sides. These two fillets are smooth curves, essentially rounded corners, denoted as the left inner radius fillet AL and the right inner radius fillet AR. The fillets AL and AR (rounded corners) are designed to maximize the utilization of the magnetic core's volume. Sharp corners would leave unused space within the magnetic core, reducing its effectiveness. Rounded corners allow the magnetic flux to flow more efficiently. In the embodiment, the radius R1 of curvature of the left inner radius fillet AL is equal to the radius R2 of curvature of the right inner radius fillet AR. Further, the radius R1 of curvature of the left inner radius fillet AL and the radius R2 of curvature of the right inner radius fillet AR are greater than 15 micrometers.

In aforementioned embodiment, both the radius R1 of curvature of the left inner radius fillet AL and the radius R2 of curvature of the right inner radius fillet AR are greater than 15 micrometers. This constraint is in place because the copper wire (conductor 10) is embedded to the magnetic powder material mold 11 by using a stamping process. The stamping tool cannot create perfectly sharp corners. Therefore, the embodiment sets the lower limit for the radius of curvature of the inner radius fillet at 15 micrometers to accommodate this manufacturing constraint. Moreover, such design of the right inner radius fillet AR and the left inner radius fillet AL also increases the utilization of the magnetic core's volume and allow the magnetic flux to flow more efficiently. In the power inductor component 100, the cross-sectional area ratio of the conductor 10 to the third surface S3 ranges from 35% to 60%. The volume ratio of the conductor 10 to the integral structure ranges from 20% to 50%. For example, the conductor cross-sectional area ratio is 48.65% for 1N5 type and 44.2% for 1N0 type. The conductor volume ratio is 32.7% for 1N5 type and 25.2% for 1N0 type.

Further, in the power inductor component 100, an insulation layer can be introduced. The insulation layer can be formed on a surface of the conductor 10. The conductor 10 is electrically isolated from the first magnetic powder portion 11a. The conductor 10 is electrically isolated from the second magnetic powder portion 11b. In other words, the insulation layer is an optional component and is designed to provide electrical isolation between the conductor 10 and the magnetic powder material mold 11. The insulation layer can be made of various materials, such as polymers or ceramics, depending on the specific requirements of the application. The primary function of the insulation layer is to prevent any electrical contact between the conductor 10 and the magnetic material, ensuring that the current flows only through the conductor 10. Introducing the insulation layer can minimize energy losses and improve the overall efficiency of the power inductor component 100. Additionally, the insulation layer can reduce noise and electromagnetic interference (EMI).

In the power inductor component 100, the manufacturing process involves a series of steps. First, a U-shaped core (say, the first magnetic powder portion 11a) is formed using a cold-press molding process. This U-shaped core is the base structure for the power inductor component 100. Then, a pre-formed conductor, typically made of copper, is inserted into the U-shaped core. Specifically, the conductor 10 is designed to have less than one turn, meaning it does not form a complete loop. After the conductor 10 is in place, an I-shaped piece (say, the second magnetic powder portion 11b) is inserted to fill the space in the conductor 10. This creates a closed magnetic path. Finally, the entire assembly is subjected to a hot-press molding process. This process compresses and heats the materials, fusing them into a single, solid structure, resulting in a compact and robust power inductor component 100.

As previously mentioned, the power inductor component 100 can significantly reduce AC losses. AC losses in inductors are caused by factors such as the skin effect and the proximity effect, which increase with frequency and load current. However, the design of the power inductor component 100 can efficiently utilize the volume of the magnetic core and reduce AC losses due to several factors. First, the integral structure of the power inductor component 100 eliminates gaps between the conductor and the magnetic powder material mold, reducing leakage flux. Second, the specific dimensions of the conductor, including the width, the height, and the corner radius, are designed to minimize the skin effect and the proximity effect, which are major contributors to AC losses. For example, the conductor 10 in the power inductor component 100 can be designed with a rectangular cross-section, rather than a circular or square shape, to minimize the skin effect and the proximity effect. Any reasonable component design falls into the scope of the embodiments.

To sum up, the embodiments disclose a power inductor component. The power inductor component is designed to overcome the limitations of traditional winding processes and composite magnetic core structures. It is achieved by utilizing a specific size formula for the conductor and a one-piece molding structure made of magnetic powder material. This design allows for efficient use of the magnetic core volume and significantly reduces AC losses caused by current and voltage changes in AC circuits. The power inductor component also optimizes the ratio of the conductor's side width to the component's length and width, maximizing the contact area between the conductor and magnetic powder material to prevent magnetic core cracking. As a result, the design of the power inductor component is particularly well-suited for use in electronic devices that require high efficiency and compact size, such as smartphones, tablets, and laptops.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A power inductor component comprising:
a conductor comprising:
two bending portions; and
two electrode portions respectively attached to the two bending portions; and
a magnetic powder material mold, forming an integral structure with the conductor, wherein the conductor is embedded in the integral structure, the magnetic powder material mold comprising:
a first magnetic powder portion; and
a second magnetic powder portion;
wherein the conductor has less than one turn, the first magnetic powder portion is disposed on an outer side of the conductor, the second magnetic powder portion is disposed on an inner side of the conductor, the integral structure comprises a first surface and a second surface opposite to each other, a third surface and a fourth surface opposite to each other, and a fifth surface and a sixth surface opposite to each other.

2. The power inductor component of claim 1, wherein the two bending portions are in contact with the first surface and the second surface of the integral structure, respectively, and the two electrode portions are in contact with the third surface of the integral structure.

3. The power inductor component of claim 1, wherein a component length of the integral structure is a distance between the first surface and the second surface, a long sidewall width of the integral structure is a distance between a surface of a short side of the conductor and the first surface of the integral structure, and a ratio of the long sidewall width to the component length ranges from 5% to 15%.

4. The power inductor component of claim 3, wherein a ratio range of the long sidewall width to the component length ranges from 6.25% to 9.37%.

5. The power inductor component of claim 4, wherein the long sidewall width is about 0.075 mm (millimeter), and the component length is about 1.0 mm.

6. The power inductor component of claim 1, wherein a component width of the integral structure is a distance between the fifth surface and the sixth surface, a short sidewall width of the integral structure is a distance between a surface of a long side of the conductor and the fifth surface of the integral structure, and a ratio of the short sidewall width to the component width ranges from 10% to 30%.

7. The power inductor component of claim 6, wherein a ratio of the short sidewall width to the component width ranges from 10.7% to 25%.

8. The power inductor component of claim 7, wherein the short sidewall width is about 0.075 mm (millimeter), and the component width is about 0.5 mm.

9. The power inductor component of claim 1, wherein an inner space height of the conductor is a vertical distance between a top surface of the second magnetic powder portion contacting the conductor and the two electrode portions of the conductor, an inner space length of the conductor is a horizontal distance between the two electrode portions, and a relationship between the inner space height and the inner space length satisfies:
$$- 2.5 mm ( millimeter ) < ( 2 \times B - A ) < 2.5 mm ( millimeter )$$
where A is the inner space length, and B is the inner space height.

10. The power inductor component of claim 1, wherein the conductor further comprises:
a U-shaped portion;
wherein a base portion of the U-shaped portion serves as the two electrode portions, and the U-shaped portion comprises a left inner radius fillet and a right inner radius fillet, and a radius of curvature of the left inner radius fillet is equal to a radius of curvature of the right inner radius fillet.

11. The power inductor component of claim 10, wherein the radius of curvature of the left inner radius fillet and the radius of curvature of the right inner radius fillet are greater than 15 micrometers.

12. The power inductor component of claim 1, wherein the two electrode portions are covered with a Nickel layer and a Tin layer.

13. The power inductor component of claim 1, wherein the two electrode portions are covered with a Tin layer.

14. The power inductor component of claim 1, further comprising:
an insulation layer formed on a surface of the conductor;
wherein when the conductor is disposed in the integral structure, the conductor is electrically isolated from the first magnetic powder portion, and the conductor is electrically isolated from the second magnetic powder portion.

15. The power inductor component of claim 1, wherein a cross-sectional area ratio of the conductor to the third surface ranges from 35% to 60%, and a volume ratio of the conductor to the integral structure ranges from 20% to 50%.

16. The power inductor component of claim 1, wherein the conductor comprises a Copper material.

17. The power inductor component of claim 1, wherein the first magnetic powder portion and the second magnetic powder portion are a same material type.

18. The power inductor component of claim 1, wherein the first magnetic powder portion and the second magnetic powder portion are different material types.

19. The power inductor component of claim 1, wherein the first magnetic powder portion is a U-shaped powder material portion, and the second magnetic powder portion is an I-shaped powder material portion.
